(19) United States
(12) Patent Application Publication
(10) Pub. No.: US 2002/0174198 A1
(43) Pub. Date: Nov. 21, 2002

(54) Management of networked devices

(75) Inventor: Steven L. Halter, Rochester, MN (US)

Correspondence Address: Eric D. Levinson, Imation Corp., Legal Affairs, P.O. Box 64898, St. Paul, MN, 55164-0898, US

(73) Assignee: Imation Corp.

(21) Appl. No.: 09/858,698

(22) Filed: May 16, 2001

(51) Int. Cl. G06F 15/173

(52) U.S. Cl. 709/220; 709/223

(57) ABSTRACT

Automatic registration of diverse device types with management software is facilitated by creating the most specific device facade possible based on available information. Based on this information, a generic registration module delegates creation of the device facade to a registration module that is more specific to the particular device, if one is available. If no more specific registration module is available, the generic registration module creates the facade itself.

### TECHNICAL FIELD

The invention relates to networked devices and, more particularly, to management of networked devices.

### BACKGROUND

In a network of devices, a number of various types of devices typically need to be discovered and managed. Generally, management software interacts with these devices using software representations known as facades. Conventional device management software typically requires specific knowledge about a device in order to operate on the device. As a result, for example, management software might only display and be able to work with devices for which it had been pre-programmed to recognize.

Networked environments are thus somewhat limited in flexibility because the management software typically can only work with certain types of devices. Using other types of devices with the network is difficult without registering them with the management software. A network administrator can register some device type information manually, but this process is often time-consuming.

### SUMMARY

According to various implementations of the invention, automatic registration of diverse device types with management software is facilitated by creating the most specific representation of a device possible based on the current knowledge about the device. When a device is discovered, the fact of the device's existence and sufficient information to categorize the device type is passed to a generic registration module that is responsible for creating a device facade that represents the device. Based on the available information about the device, the generic registration module delegates creation of the device facade to a registration module that is more specific to the particular device, assuming such a registration module is available. If no such registration module is available, the generic registration module creates the facade itself.

One embodiment is directed to automatic registration by obtaining information relating to a device. A generic registration module determines whether a more specific registration module for the device exists based on the obtained information. If a more specific registration module exists, the generic registration module directs the more specific registration module to create the facade. If no more specific registration module exists, the generic registration module creates the facade.

In another embodiment, information is obtained relating to a device discovered on a network. This information includes at least one of protocol information and device type information. A device type-specific registration module creates a facade when the device type-specific registration module matches the device type information. A protocol-specific registration module creates the facade when no device type-specific registration module matches the device type information, but the protocol-specific registration module matches the protocol information. When neither a device type-specific registration module nor a protocol-specific registration module matches the discovered device, a generic registration module creates the facade.

Other embodiments of the invention include computer-readable media and administration devices for creating a device facade in this manner. The above summary of the invention is not intended to describe every embodiment of the invention. The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 illustrates a system according to an embodiment of the invention.

FIG. 2 shows an implementation of an administration device of FIG. 1.

FIG. 3 depicts a hierarchy of registration modules in one embodiment of the invention.

FIG. 4 is a flow chart illustrating a mode of operation of the registration module of FIG. 2, according to another embodiment of the invention.

### DETAILED DESCRIPTION

In general, the invention facilitates automatic registration of diverse device types with management software by creating the most specific representation of a device possible based on the current knowledge about the device. When a device is discovered, the fact of the device's existence and sufficient information to relocate the device and begin categorizing the device type is passed to a generic registration module that is responsible for creating a device facade that represents the device. Based on the available information about the device, the generic registration module delegates creation of the device facade to a registration module that is more specific to the particular device. If no more specific registration module is available, the generic registration module creates the facade itself.

According to various embodiments of the invention, a variety of discovery agents can be used in a number of ways to discover different types of devices placed on a network. Each discoverer transmits to the generic registration module the fact that it discovered a device and the information it knows about the type of the device. The generic registration module uses this information to either create a device facade or, if possible, to delegate creation of the device facade to a more specific registration module that can create a facade for the specific device type. As a result, the invention facilitates management of devices that are not specifically known to the management software. In addition, flexibility is enhanced because more specific registration modules can be added to the management software without having to reprogram any code.

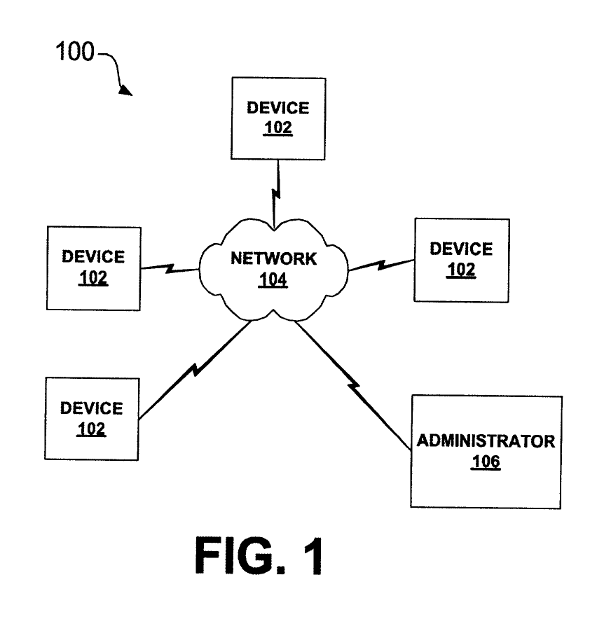

FIG. 1 illustrates a system 100 according to an example embodiment of the invention. System 100 includes one or more devices 102 that communicate with each other via a network 104. Examples of devices 102 that can be connected to network 104 include, but are not limited to, storage devices, switches, and printers. In one embodiment, devices 102 include Network Attached Storage (NAS) devices, but the invention is not so limited. Network 104 may be implemented using any communication network, such as an Ethernet-based network running TCP/IP, NetBEUI or other communication protocols. An administration device 106 is also coupled to network 104 and is responsible for managing the various devices connected to network 104.

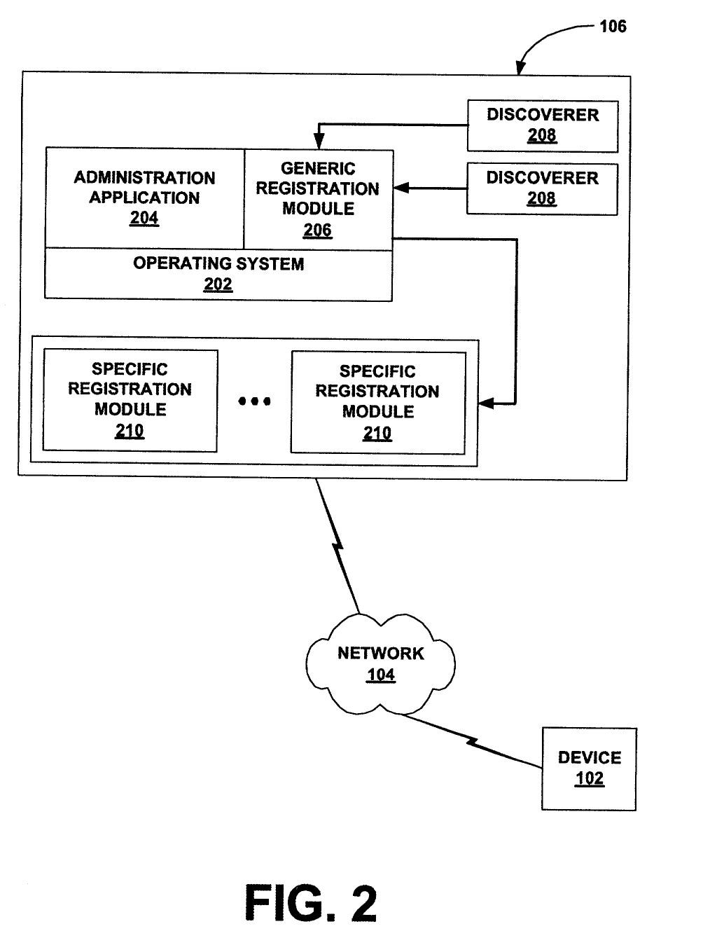

FIG. 2 shows an example implementation of administration device 106 configured according to the invention. Administration device 106 may include a programmable processor and a network interface to communicate with network 104. Administration device 106 may be a network device dedicated to administering network 104, or may be a process executing on a device 102. Operating system 202 provides a multi-tasking operating environment in which an administration application 204 and a generic registration module 206 operate. Example operating systems include Microsoft™ Windows™ 2000, Linux and Unix. When a new device is connected to network 104 of FIG. 1, a discovery agent 208 discovers the new device in any of a number of ways and transmits to generic registration module 206 an indication that it has discovered a device, as well as the information that it knows about the discovered device. Several discovery agents 208 may be present, and they may be either distinct from administration device 106 or implemented as modules within administration device 106. Each discovery agent 208 may comprise a separate software process executing within the operating environment provided by operating system 202. Alternatively, multiple discovery agents 208 can be integrated into a single software process executing within the operating environment.

Discovery agents 208 may implement a group of classes that use various techniques, such as Simple Network Management Protocol (SNMP) or Common Information Model (CIM), to discover devices 102 attached to network 104. The discovery process may be either active, such that discovery agent 208 is actively searching for its targeted devices, or passive, such that discovery agent 208 waits to be notified of the existence of a device. In either case, discovery agent 208 collects enough information about the discovered device to identify the category of the device, e.g., a RAID, JBOD, host, switch, specific data service, etc., and to identify the device and the appropriate method for communicating with the device. In one embodiment, discovery agent 208 packages the collected information into a specific Entry subclass and places the resulting packet into a Java space for processing by generic registrations module 206.

There may be different types of discovery agents 208 for different types of devices 102. In a multiple-discoverer environment, each discovery agent 208 is responsible for discovering a different category of devices. Each discovery agent 208 may also be responsible for a different technique of discovery, e.g., SNMP cold start traps, IP address pings, configuration files, etc. The discovery agents 208 should operate independently of each other to facilitate adding discoverers to and removing discoverers from system 100 without affecting the operation of other discovery agents 208. In addition, redundant discovery coverage is preferably minimized or eliminated to avoid creation of multiple device facades for a single device. If the discovery process results in multiple packets of collected information being placed in the Java space for the same device, generic registration module 206 must recognize the duplicate packets and ignore them appropriately. Accordingly, it is preferable to reduce the likelihood of redundant discovery.

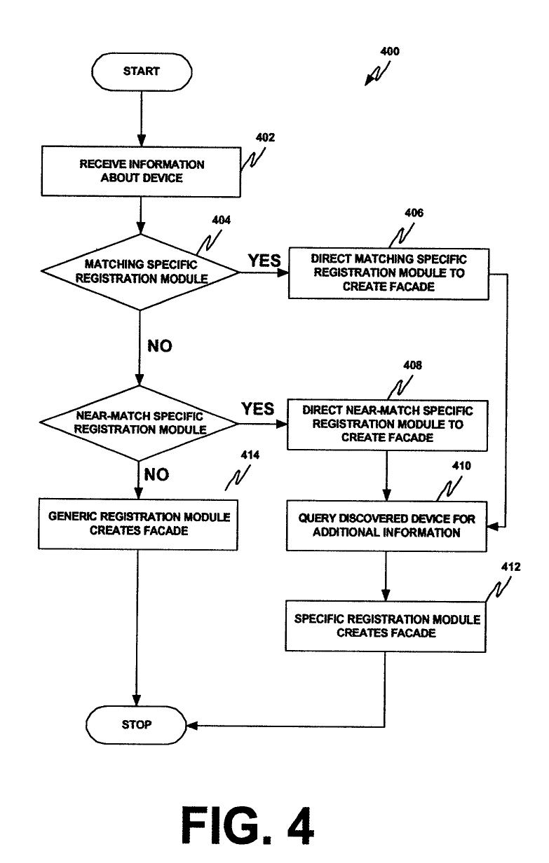

After discovery agent 208 communicates the collected information to the generic registration module 206, generic registration module 206 attempts to find a specific registration module 210 to create the device facade for the particular device type. Several specific registration modules 210 may be present, and they may be either implemented as modules within administration device 106, as shown in FIG. 2, or distinct from administration device 106, i.e., executing on other devices 102 of FIG. 1. If generic registration module 206 cannot find a more specific registration module 210 to create the device facade, generic registration module 206 creates the device facade itself. This process is described more fully below in connection with FIG. 4.

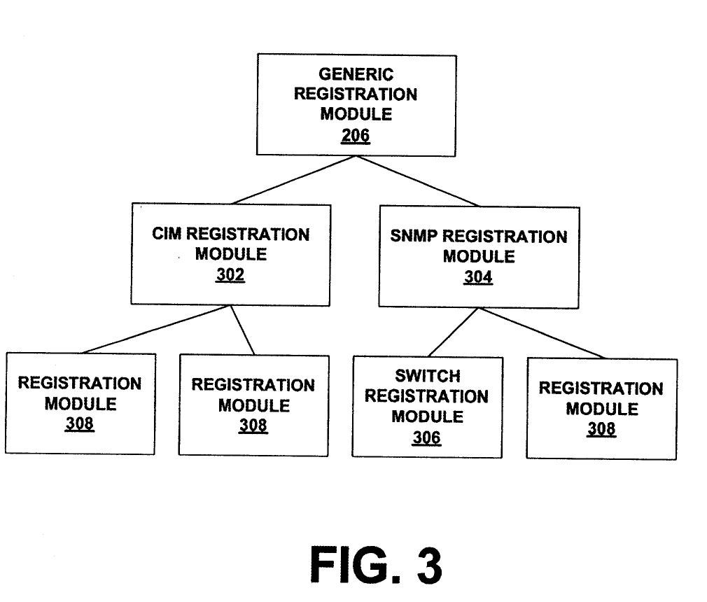

FIG. 3 depicts an example hierarchy of registration modules in one embodiment of the invention. With the exception of generic registration module 206, all of the registration modules in FIG. 3 are examples of specific registration modules 210 of FIG. 2. Generic registration module 206 is at the top level of the hierarchy. Immediately below generic registration module 206 in the hierarchy are protocol-specific registration modules, including, for example, generic CIM registration module 302 and generic SNMP registration module 304. Under each protocol-specific registration module are device-type registration modules, including a switch registration module 306 under the SNMP registration module 304, as well as other registration modules 308. Though not shown in FIG. 3, other registration modules may be located below these device-type registration modules in the hierarchy. To locate the most specific registration module, generic registration module 206 can either traverse the hierarchy in a top-down or a bottom-up manner. For example, generic registration module 206 may begin by searching the bottom, i.e., most specific, level of the hierarchy to locate a registration module that exactly matches the discovered device. If no registration module exactly matches the discovered device, generic registration module 206 then traverses the next higher level of the hierarchy, for example, the level containing the protocol-specific registration modules. Alternatively, generic registration module 206 may immediately delegate the task of creating the device facade to one of the protocol-specific registration modules, which would in turn delegate the task to an even more specific registration module.

Administration device 106 typically includes or is used in conjunction with some form of computer readable media. By way of example, and not limitation, computer readable media may comprise computer storage media and/or communication media. Computer storage media includes volatile and nonvolatile, removable and nonremovable media implemented in any method or technology for storage of information such as processor-readable instructions, data structures, program modules, or other data. Computer storage media includes, but is not limited to, random access memory (RAM), read-only memory (ROM), EEPROM, flash memory, CD-ROM, digital versatile discs (DVD) or other optical storage, magnetic cassettes, magnetic tape, magnetic disk storage or other magnetic storage devices, or any other medium that can be used to store the desired information and that can be accessed by administration device 106. Communication media typically embodies processor readable instructions, data structures, program modules, or other data in a modulated data signal, such as a carrier wave or other transport medium and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Computer readable media may also include combinations of any of the media described above.

FIG. 4 is a flow chart illustrating an example mode of operation 400 of generic registration module 206 of FIG. 2. In a particular embodiment, generic registration module 206 receives from a discovery agent 208 information indicating discovery of a device and the information that discovery agent 208 knows about the type of the discovered device (402). Generic registration module 206 then determines whether a specific registration module 210 exists for creating a device facade for the exact device type, e.g., the particular model of the device (404). This determination is made, for example, by referencing a table based on information passed by the discovery agent 208 that discovered the device. If a specific registration module 210 is found that exactly matches the discovered device, generic registration module 206 directs the matching specific registration module 210 to create the device facade (406).

If no specific registration module 210 exactly matches the discovered device, generic registration module 206 then attempts to find the specific registration module 210 that most closely matches the discovered device (408). For example, if the device is an unknown type of switch, the appropriate specific registration module 210 might be a generic switch registration module. In this example, the generic switch registration module may be able to determine some more specific information about the switch that would allow it to delegate creation of the switch facade to a more specific switch registration module, e.g., a switch registration module for a particular manufacturer's switches. If there is no more specific switch registration module, the generic switch registration module may create the device facade itself. Generally, once the most specific registration module 210 has the responsibility of creating the device facade, it will query the discovered device for additional information (410) and then create the device facade (412).

If generic registration module 206 cannot find a more specific registration module 210 to create the management facade, the generic registration module creates the management facade itself (414). In any case, the registration module that is ultimately responsible for creating the device facade packages the device facade in a class data object. The registration module then places the data object in a Java space from which it can be retrieved by the management software to administer the device.

At each level of the device facade creation process, a registration module only needs to possess a limited amount of knowledge about the discovered device. For example, generic registration module 206 only needs to know how to find a specific registration module 210 that exactly matches the discovered device or, in the alternative, how to pass the device information to a specific registration module 210 that might be able to create the device facade. At each level, a registration module can determine more information about the type of the device until either all information is found or the most information that can be recognized currently is found.

In a particular embodiment of the invention, additional registration modules can be added to system 100 without having to reprogram any code. When a new registration module is added, generic registration module 206 can direct it to create device facades without further intervention.

A specific operational example will further illustrate the principles of the invention. In this example, a network is assumed to contain two switches. One of these switches is a QLogic-type switch, while the other is a Brocade-type switch. If a specific registration module 210 for creating a QLogic switch facade is present, it creates a facade that specifically characterizes the QLogic-type switch. The Brocade-type switch, on the other hand, may not be recognized as a specific type of switch, and may not even be recognized as a switch at all. It is, however, recognized as a device that communicates using the Simple Network Management Protocol (SNMP), as it was found by an SNMP discoverer.

Based on this information, generic registration module 206 sends the Brocade-type switch information to a particular specific registration module 210, namely, a generic SNMP device registration module. The generic SNMP device registration module might then determine that the SNMP device supports the standard mechanisms for an SNMP switch, and delegate creation of the facade to an SNMP switch registration module, which then creates an SNMP switch facade. If no SNMP switch registration module is present, the generic SNMP device registration module creates an SNMP device facade for the Brocade-type switch. Later, if a specific registration module 210 for creating a Brocade switch facade is added to the network, it can create a Brocade-specific switch facade at that time.

If the devices were instead found by a Common Information Model (CIM) discoverer, the knowledge that the devices were CIM devices would be encoded into the information that is sent to generic registration module 206. For example, the CIM discoverer might locate a device and inform generic registration module 206 that it has found a device. Generic registration module 206 would then determine if a specific registration module 210 that matches the discovered device can be found based on the information provided by the CIM discoverer. If not, generic registration module 206 would forward the information to the generic CIM registration module.

In conclusion, the invention facilitates management of devices that are not specifically known to the management software. Flexibility is enhanced in that more specific registration modules can always be added to the management software without having to reprogram any code.

1. A method of managing a device comprising:
obtaining information relating to the device;
invoking a generic registration module to determine whether a more specific registration module for the device exists based on the obtained information;
invoking the more specific registration module to create a facade when a more specific registration module exists; and
invoking the generic registration module to create the facade when the more specific registration module does not exist.

2. The method of claim 1, wherein using the generic registration module to determine whether a more specific registration module for the device exists comprises:
determining whether a specific registration module exists that exactly matches the device; and
if no specific registration module exists that exactly matches the device, identifying a registration module that most nearly matches the device.

3. The method of claim 1, further comprising:
using the more specific registration module to obtain additional information relating to the device; and
creating the facade at least in part as a function of the additional information.

4. The method of claim 3, further comprising:
using the additional information to identify a most specific registration module; and
directing the most specific registration module to create the facade.

5. The method of claim 1, further comprising:
packaging the obtained information into a data object; and
placing the data object into a Java space.

6. The method of claim 1, further comprising:
packaging the facade into a data object; and
placing the data object into a Java space.

7. A method of managing a device discovered on a network, the method comprising:
obtaining information relating to the device, the information including at least one of protocol information and device type information;
invoking a device type-specific registration module to create a facade when the device type-specific registration module matches the device type information;
invoking a protocol-specific registration module to create the facade when no device type-specific registration module matches the device type information and the protocol-specific registration module matches the protocol information; and
invoking a generic registration module to create the facade when no device type-specific registration module matches the device type information and no protocol-specific registration module matches the protocol information.

8. A device management system, comprising:
a device;
at least one discoverer to obtain information relating to the device;
a plurality of specific registration modules to create facades for respectively associated device types; and
a generic registration module, operatively coupled to the specific registration modules, and configured to determine whether one of the specific registration modules is associated with a device type of the device, to direct one of the specific registration modules to create the facade, and, if none of the specific registration modules is associated with the device type of the device, to create the facade.

9. The device management system of claim 8, wherein the generic registration module is further configured to:
determine whether a specific registration module exists that exactly matches the device; and
if no specific registration module exists that exactly matches the device, identify a registration module that most nearly matches the device.

10. The device management system of claim 8, wherein a specific registration module is further configured to obtain additional information relating to the device and to create the facade at least in part as a function of the additional information.

11. The device management system of claim 10, wherein the specific registration module is further configured to:
use the additional information to identify a most specific registration module; and
direct the most specific registration module to create the facade.

12. The device management system of claim 8, wherein the discoverer is configured to:
package the obtained information into a data object; and
place the data object into a Java space.

13. The device management system of claim 8, wherein a specific registration module is configured to:
package the facade into a data object; and
place the data object into a Java space.

14. The device management system of claim 8, wherein the at least one discoverer comprises one of a Simple Network Management Protocol (SNMP) discoverer and a Common Information Model (CIM) discoverer.

15. A network device administrator, comprising:
a plurality of specific registration modules to create management facades for network devices; and
a generic registration module to select one of the registration modules based at least in part on device-specific information obtained for a discovered device,
wherein the generic registration module creates a management facade for the discovered device when none of the specific registration modules is associated with a device type of the device.

16. The network device administrator of claim 15, wherein the generic registration module:
determines whether a specific registration module exists that exactly matches the device; and
if no specific registration module exists that exactly matches the device, identifies a registration module that most nearly matches the device.

17. The network device administrator of claim 15, wherein a specific registration module is further configured to obtain additional information relating to the device and to create the facade at least in part as a function of the additional information.

18. The network device administrator of claim 17, wherein the specific registration module is further configured to:
use the additional information to identify a most specific registration module; and
direct the most specific registration module to create the facade.

19. The network device administrator of claim 15, further comprising at least one discoverer to obtain information relating to the device.

20. The network device administrator of claim 19, wherein the discoverer is configured to:
package the obtained information into a data object; and
place the data object into a Java space.

21. The network device administrator of claim 19, wherein the at least one discoverer comprises at least one of a Simple Network Management Protocol (SNMP) discoverer and a Common Information Model (CIM) discoverer.

22. The network device administrator of claim 15, wherein a specific registration module is configured to:
package the facade into a data object; and
place the data object into a Java space.

23. A computer-readable medium having computer-executable instructions stored thereon for:
obtaining information relating to a device;
using a generic registration module to determine whether a more specific registration module for the device exists based on the obtained information and, if a more specific registration module exists, directing the more specific registration module to create the facade; and
if no more specific registration module exists, using the generic registration module to create the facade.

24. The computer-readable medium of claim 23, wherein using the generic registration module to determine whether a more specific registration module for the device exists comprises:
determining whether a specific registration module exists that exactly matches the device; and
if no specific registration module exists that exactly matches the device, identifying a registration module that most nearly matches the device.

25. The computer-readable medium of claim 23, further comprising computer-executable instructions for using the more specific registration module to obtain additional information relating to the device and for creating the facade at least in part as a function of the additional information.

26. The computer-readable medium of claim 25, further comprising computer-executable instructions for:
using the additional information to identify a most specific registration module; and
directing the most specific registration module to create the facade.

27. The computer-readable medium of claim 23, further comprising computer-executable instructions for:
packaging the obtained information into a data object; and
placing the data object into a Java space.

28. The computer-readable medium of claim 23, further comprising computer-executable instructions for:
packaging the facade into a data object; and
placing the data object into a Java space.
